(19) United States
(12) Patent Application Publication
(10) Pub. No.: US 2016/0367846 A1
(43) Pub. Date: Dec. 22, 2016

(54) Flame Suppression Grenade

(71) Applicant: Lee Haines, Hobbs, NM (US)

(72) Inventor: Lee Haines, Hobbs, NM (US)

(21) Appl. No.: 15/096,018

(22) Filed: Apr. 11, 2016

Related U.S. Application Data
(60) Provisional application No. 62/180,809, filed on Jun. 17, 2015.

(51) Int. Cl. A62C 19/00

(52) U.S. Cl. CPC A62C 19/00

(57) ABSTRACT

A flame suppression grenade provides an activation pin, a gyroscope to keep the grenade upright, a flame suppressant cartridge, one or more time-released carbon dioxide (CO₂) cartridges, and a plurality of small nozzles for dispensing the CO₂ and flame suppressant under high pressure. The nozzles are canted to the side to allow the top portion of the grenade to spin rapidly, dispersing CO₂ and flame suppressant in all directions and covering most of the room.

### CROSS-REFERENCE TO RELATED APPLICATIONS

This Application claims the benefit of U.S. Provisional Application No. 62/180809, filed Jun. 17, 2015, which is hereby incorporated by reference.

### STATEMENT REGARDING FEDERALLY SPONSORED RESEARCH OR DEVELOPMENT

Not Applicable

### PARTIES TO A JOINT RESEARCH AGREEMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The invention relates generally to firefighting equipment and in particular to a flame suppression grenade. For firefighters, one of the most dangerous conditions of the job is a flame over, when a room has become completely engulfed in flames. Due to the materials being used in recent building construction, particularly in residences, the danger of flame over has become greater in recent years. The deaths of firefighters, and the civilians they are trying to save are often caused by flame overs in situations where a fire hose line cannot reach. A highly portable implement which can be used to disperse “Purple K” or some other flame suppressant to knock down and suppress flames quickly in such circumstances would save lives. Alternatively, a flame suppression grenade, which rapidly and efficiently disperses carbon dioxide gas to suppress flames in a room, would resolve this problem.

A search of the prior art reveals various fir suppressant grenades which have been developed to provide the use with a means for suppressing fire. None are closely related to the present invention, but several include features which resemble those of the present invention. Each has proven to be less than satisfactory in its own way.

Fire Retardant Delivery System, U.S. Pat. No. 6,725,941, provides a method for delivering a fire suppressant by encasing a slurry or gas fire retardant within a solid shell made of the same fire retardant. The device is then thrown. Upon impact, the solid shell breaks and the slurry or gas retardant is released into the environment. However, if the solid shell does not break, then the flame suppressant would not be released.

Method of Manufacturing Fire-Extinguishing Agent and Throwing-type Fire Extinguisher, U.S. Pat. No. 8,453,752, provides a device destructible container. The container holds a fire suppressant within and when activated drops the fire suppressant into a foaming agent. The foaming agent expands and eventually bursts the container which projects the fire suppressant outward. This device uses pressure to break the container. However, this design could fail if the container breaks or cracks before sufficient pressure is built up or could potentially launch pieces of the container at a high enough velocity to cause extra damage.

Fire Suppression Composition and Device, U.S. Pat. No. 6,217,788, provides a device which dispenses a fire suppression gas. The device is a cylindrical container with a passageway on the top end. However, this design could fail if the cylinder falls over or the passageway is blocked due to positioning or placement.

Hand Grenade Fire Extinguisher, U.S. Pat. No. 297,075, provides a glass spherical container which holds fire suppressant gases. The grenade is shattered either by impact from throwing the device or from the heat of the fire into which it is thrown. However, the shattering of the glass shell would either leave behind glass fragments or throw glass fragments throughout the room which can cause additional dangers to anyone in the room at the time of destruction or who enter later.

Fire Grenade, U.S. Pat. No. 366,901, provides a spherical device which holds a fire suppressant. When activated the spherical device flips over and spills its contents on the fire below. However, this device is only functional when placed within a room prior to a fire and is only capable of extinguishing fires below the device.

Fire Grenade, U.S. Pat. No. 153,854, provides a spherical device which holds a fire suppressant. When activated the spherical device presumably breaks and spills its contents on the fire below. However, this device is only functional when placed within a room prior to a fire and is only capable of extinguishing fires below the device.

Hand-Grenade for Fire-Extinguishing Purposes, U.S. Pat. No. 638,781, provides a glass sphere which contains a fire suppressant. The device further provides loaded springs within the sphere. These springs expand when heated causing the glass sphere to break and disperse the fire suppressant. As with the other device listed above, this device adds the danger of launching shards of broken glass throughout the room into which it is thrown.

The prior art inventions require the use to throw the device into a room where the container shatters leaving behind broken shards (generally of glass) throughout the room. Alternatively, other prior art dispenses a fire suppressant though a single nozzle which could easily become blocked or ineffective. The present invention has been developed for the purpose of addressing and resolving these disadvantages. A flame suppression grenade, which includes multiple nozzles for the distribution of a fire suppressant as well as a gyroscope to ensure the device remains upright would resolve these problems.

### SUMMARY OF THE INVENTION

Accordingly, the invention is directed to a flame suppression grenade. The grenade provides an activation pin, a gyroscope to keep the grenade upright, a flame suppressant cartridge, one or more time-released carbon dioxide (CO₂) cartridges, and a plurality of small nozzles for dispensing the CO₂ and flame suppressant under high pressure. The nozzles are canted to the side to allow the top portion of the grenade to spin rapidly, dispersing CO₂ and flame suppressant in all directions and covering most of the room.

Additional features and advantages of the invention will be set forth in the description which follows, and will be apparent from the description, or may be learned by practice of the invention. The foregoing general description and the following detailed description are exemplary and explanatory and are intended to provide further explanation of the invention.

### BRIEF DESCRIPTION OF THE DRAWINGS

The accompanying drawings are included to provide a further understanding of the invention and are incorporated into and constitute a part of the specification. They illustrate one embodiment of the invention and, together with the description, serves to explain the principles of the invention.

FIG. 1 is a left side view of the first exemplary embodiment, displaying the grenade 10, the activation pin 11, the top portion 12, the nozzles 13, the strap 14, and the CO₂ cartridges 15.

FIG. 2 is a top view of the first exemplary embodiment, displaying the grenade 10, the activation pin 11, the top portion 12, the nozzles 13, and the CO₂ cartridge 15.

FIG. 3 is a right side view of the first exemplary embodiment, displaying the grenade 10, the activation pin 11, the top portion 12, the nozzles 13, and the strap 14.

FIG. 4 is a bottom view of the first exemplary embodiment, displaying the grenade 10, the nozzles 13, the strap 14, the CO₂ cartridge 15, and the base 16,

FIG. 5 is a front view of the first exemplary embodiment, displaying the grenade 10, the activation pin 11, the top portion 12, the nozzles 13, and the CO₂ cartridges 15.

FIG. 6 is a front cross-sectional view of the first exemplary embodiment, displaying the grenade 10, the gyroscope 30, and the internal cartridge 31.

FIG. 7 is a front cross-sectional view of the third exemplary embodiment, displaying the grenade with a cylindrical body 40, a hose 41, the suppressant cartridge 43, and a wire 44.

FIG. 8 is a front perspective view of the third exemplary embodiment, displaying the propellant cartridge 42 and the hose 41.

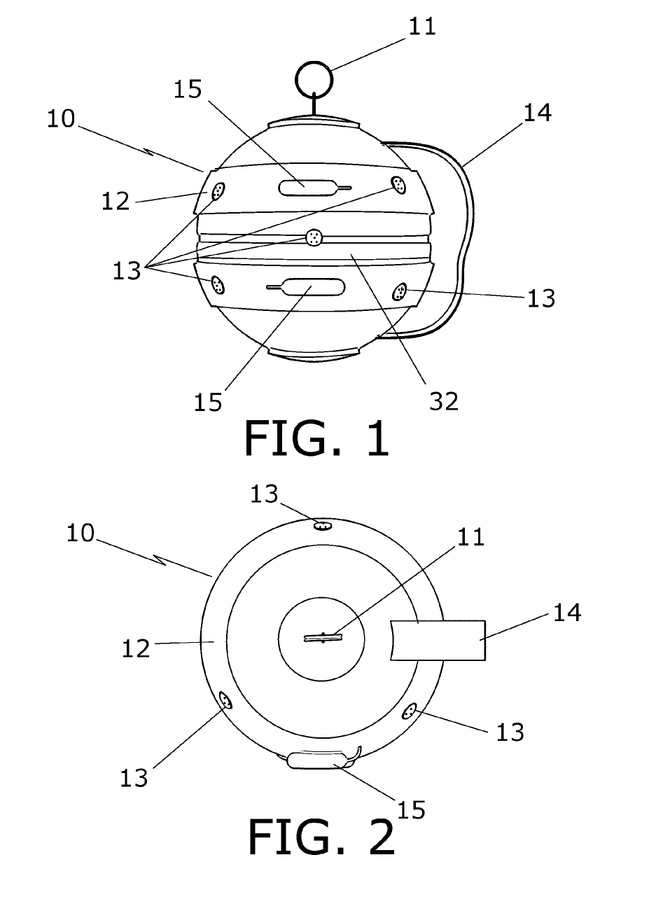

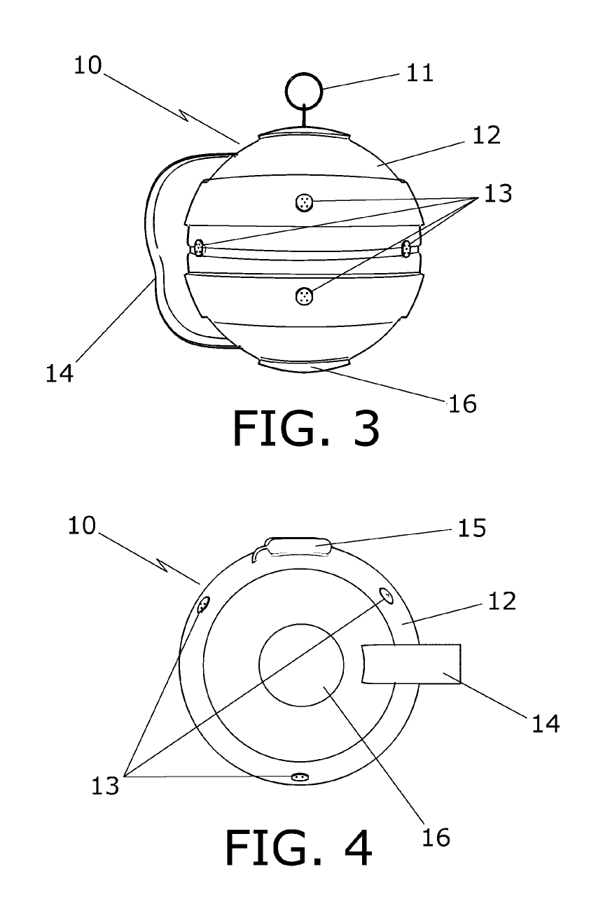

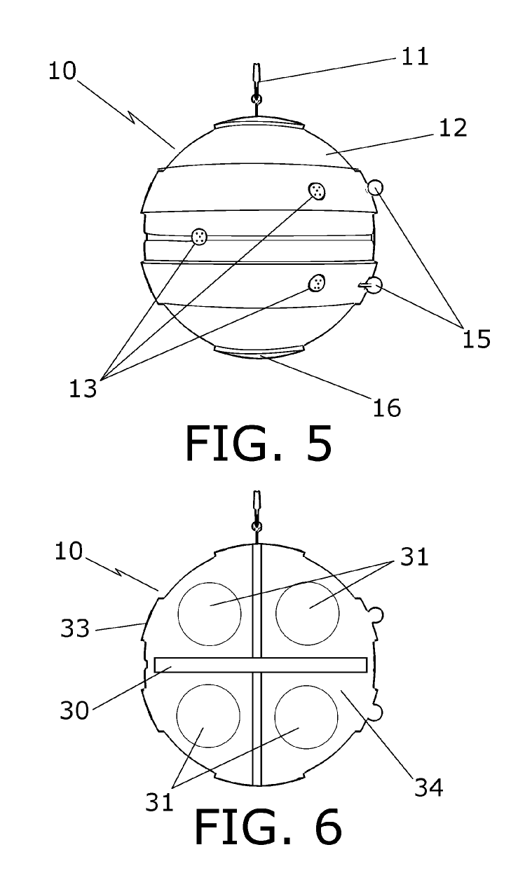

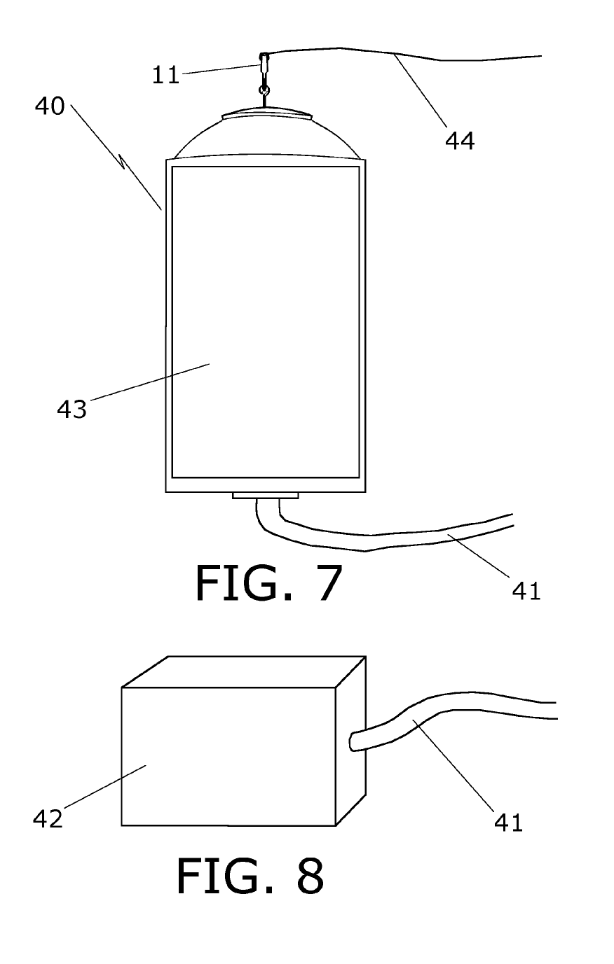

### DETAILED DESCRIPTION OF THE INVENTION

Referring now to the invention in more detail, the invention is directed to a flame suppression grenade 10.

The first exemplary embodiment is comprised of a body 32. In the first exemplary embodiment the body 32 is made of a spherical grenade 10, preferably four inches in diameter, which provides an activation pin 11, an interior gyroscope 30 to keep the grenade 10 upright, one or more propellant cartridge 15, the propellant cartridge 15 preferably being a time-released carbon dioxide (CO₂) cartridge, a suppressant cartridge 31 containing Purple K or some other flame suppressant within an interior cavity 34, and a plurality of small nozzles 13 on the exterior surface 33, for spraying the flame suppressant under high pressure. The nozzles 13 are canted to the side to allow the top portion 12 of the grenade to spin rapidly, dispersing flame suppressant in all directions and covering most of the room. Alternately, the CO₂ cartridges 15 may contain compressed air or some other inert propellant. The top portion 12 of the grenade 10 spins on a small circular base 16 during operation. A strap 14 is provided at the rear of the grenade 10, which may be used to carry and throw the grenade 10.

Preferably, operation of the grenade 10 is entirely mechanical for maximum reliability, relying on the pressurization of the CO₂ cartridges 15 and the spin of the gyroscope, optionally augmented by one or more springs. The grenade 10 is intended for use in firefighting to extinguish or suppress the fire, as a firefighter emergency egress tool or initial knock down tool by the first arriving officer on scene. The grenade 10 can be carried by search and rescue personnel who generally enter a burning structure with no fire hose line, enabling those firefighters to maintain a degree of safety, possibly extinguish a small fire or slow the growth of larger fires. Use of the grenade 10 enables firefighters to rescue victims or egress if they become trapped themselves.

The second exemplary embodiment is substantially identical in structure and function to the first exemplary embodiment, with the following modifications. In the second exemplary embodiment, the gyroscope has been removed to allow space for a substantially larger flame suppressant cartridge with greater capacity, and a larger number of nozzles 13.

The third exemplary embodiment is substantially identical in structure and function to the second exemplary embodiment, with the following modifications. In the third exemplary embodiment, the overall outer structure of the grenade 10 is a cylindrical canister 40 rather than a spherical structure. The attached CO₂ cartridges 15 have been replaced with a hose 41, leading to a propellant cartridge in the form of a compressed air pack 42 carried by the user, enabling an even larger flame suppressant cartridge 43 than in the second exemplary embodiment. A wire 44 is provided which is attached to the ring at the upper end of the activation pin 11, such that the user may pull the activation pin 11 from the grenade 10 by pulling the wire 44.

To use the first or the second exemplary embodiment, the user inserts a finger into the ring at the upper end of the activation pin 11, and pulls the activation pin 11 upward, extracting it from the grenade 10. The user then immediately rolls the grenade 10 into the location desired by the user. The gyroscope of the first exemplary embodiment causes the grenade 10 to right itself into an upright position on the base 16, allowing the top portion 12 to spin.

To use the third exemplary embodiment, the user affixes a hose from the compressed air pack to the grenade 10. The user then rolls the grenade 10 into the location desired by the user, and pulls the wire, extracting the activation pin 11 from the grenade 10.

The activation pin 11, the top portion 12, the nozzles 13, the CO₂ cartridges 15, and the base 16 are preferably manufactured from rigid, durable materials such as stainless steel, brass, plastic, and aluminum alloy. The strap 14 is preferably manufactured from a flexible, durable material such as nylon webbing

Components, component sizes, and materials listed above are preferable, but artisans will recognize that alternate components and materials could be selected without altering the scope of the invention.

While the foregoing written description of the invention enables one of ordinary skill to make and use what is presently considered to be the best mode thereof, those of ordinary skill in the art will understand and appreciate the existence of variations, combinations, and equivalents of the specific embodiment, method, and examples herein. The invention should, therefore, not be limited by the above described embodiment, method, and examples, but by all embodiments and methods within the scope and spirit of the invention.

I claim:

1. A flame suppression grenade, comprising: a body having an exterior surface and an internal cavity; said body having an activation pin attached near a top end; at least one propellant cartridge containing a propellant; at least one suppressant cartridge containing a flame suppressant; at least one nozzle; said propellant cartridge being connected to said suppressant cartridge and said suppressant cartridge being connected to said nozzle; said activation pin being mechanically connected to said propellant cartridge such that the removal of the activation pin activates the propellant cartridge, propelling the propellant into the suppressant cartridge such that the flame suppressant is sprayed out of the nozzle.

2. The flame suppression grenade of claim 1, wherein said body is spherical in shape and said at least one propellant cartridge is attached to the exterior surface of the body or stored in the interior surface of the body.

3. The flame suppression grenade of claim 2, wherein said body has a top portion and a base; said top portion being rotationally connected to the base such that said top portion rotates freely from the base around a shared central axis; said at least one nozzle is canted such that the spraying of the flame suppressant causes the top portion to rotate.

4. The flame suppression grenade of claim 3, further comprising a gyroscope within the interior cavity; wherein said gyroscope has a spin access which is shared with the central axis of the base and top portion; said gyroscope being configured such that when spinning the body stands upright with the base facing downward; and said gyroscope being configured to start spinning when the activation pin is removed.

5. The flame suppression grenade of claim 2, wherein said at least one nozzle is a plurality of nozzles; said plurality of nozzles being spread evenly across the exterior surface of the body.

6. The flame suppression grenade of claim 3, wherein said at least one nozzle is a plurality of nozzles; said plurality of nozzles being spread evenly across the exterior surface of the body; and said plurality of nozzles are canted in the same direction such that the spraying of the flame suppressant through the plurality of nozzles spins the top portion in the same direction.

7. The flame suppression grenade of claim 4, wherein said at least one nozzle is a plurality of nozzles; said plurality of nozzles being spread evenly across the exterior surface of the body; and said plurality of nozzles are canted in the same direction such that the spraying of the flame suppressant through the plurality of nozzles spins the top portion in the same direction.

8. The flame suppression grenade of claim 2, further comprising a strap; said strap being connected at two points to the body.

9. The flame suppression grenade of claim 1, wherein said body is cylindrical in shape.

10. The flame suppression grenade of claim 9, wherein said propellant cartridge is connected to said suppressant cartridge via a long hose; said propellant cartridge not being attached directly to the body of the suppression grenade.

11. The flame suppression grenade of claim 10, further comprising a long wire; said long wire being attached to the activation pin such that pulling on said long wire removes the activation pin.
